(19) United States
(12) Patent Application Publication
(10) Pub. No.: US 2018/0352988 A1
(43) Pub. Date: Dec. 13, 2018

(54) SECURE RECOVERY SYSTEM FOR DRONE DELIVERED PACKAGES

(71) Applicant: Mesa Digital, LLC, Albuquerque, NM (US)

(72) Inventors: Luis M. Ortiz, Albuquerque, NM (US); Kermit D. Lopez, Albuquerque, NM (US)

(73) Assignee: Mesa Digital, LLC

(21) Appl. No.: 15/915,794

(22) Filed: Mar. 8, 2018

Related U.S. Application Data
(60) Provisional application No. 62/468,599, filed on Mar. 8, 2017.

(51) Int. Cl. A47G 29/20; A47G 29/30; A47G 29/14; E05B 65/06; E05F 15/73; B64F 1/32

(52) U.S. Cl. CPC A47G 29/20; A47G 29/30; A47G 29/141; E05B 65/06; E05F 15/73; B64C 39/024; A47G 2029/142; A47G 2029/149; E05Y 2400/614; E05Y 2900/60; B64F 1/32

(57) ABSTRACT

Systems and methods for use in the secure recovery of drone delivered packages can include a housing, at least one electromechanically operated door securing access to the housing, and a retractable platform that can electromechanically extend from inside the housing to an area outside the housing when the at least one electromechanically operated door is opened. The retractable platform can serve as a landing pad for a delivery drone and/or as a base onto which a package can be received from a delivery drone. The retractable platform can electromechanically move back into the housing and the door can close after receiving the package. Communications components, alarms, and cameras can also be associated with the housing to facilitate its operation for package recovery and security.

### CROSS-REFERENCE TO PROVISIONAL APPLICATION

This nonprovisional patent application claims the benefit under 35 U.S.C. § 119(e) to U.S. Provisional Patent Application Ser. No. 62/468,599, filed on Mar. 8, 2017, entitled “SECURE RECOVERY SYSTEM FOR DRONE DELIVERED PACKAGES” and which is hereby incorporated by reference in its entirety.

### TECHNICAL FIELD

Embodiments are generally related to UAV (Unmanned Aerial Vehicle) devices, systems, and methods. Embodiments further relate to the delivery of packages via UAV or aerial drone. More particularly, embodiments are related to a system for the secure recovery of drone delivered packages.

### BACKGROUND

A delivery drone is an unmanned aerial vehicle (UAV) utilized to transport packages, food, or other goods. UAVs can transport medicines and vaccines, and retrieve medical samples, into and out of remote or otherwise inaccessible regions. “Ambulance drones” can rapidly deliver defibrillators in the crucial few minutes after cardiac arrests, and include livestream communication capability allowing paramedics to remotely observe and instruct on-scene individuals in how to use the defibrillators. In July 2015, the FAA approved the first such use of a drone within the United States, to deliver medicine to a rural Virginia medical clinic in a program called “Let's Fly Wisely.”

With the rapid demise of snail mail and the explosive double-digit growth of e-Commerce, postal companies have been forced to seek new ways to adapt their traditional letter delivery business models. Different postal companies from Australia, Switzerland, Germany, Singapore, and Ukraine have undertaken various drone trials as they test the feasibility and profitability of unmanned delivery drone services. Matternet is a Silicon Valley startup developing small UAVs for the delivery of lightweight goods. It had its origins in 2011 out of Singularity University, based at the NASA Ames Research Center in Moffett Field, Calif. Their transportation solution comprises small UAVs able to carry up to 1-kilogram of goods over distances of up to 20 kilometers on a battery charge. The UAVs are connected to a Cloud Software that aggregates weather, terrain, and airspace data, and creates geo-fenced aerial routes for safe flight. The system is controlled by a smartphone app. It's been reported that Matternet is also developing automatic landing stations, where the UAVs would swap batteries to extend their range. They have announced a public launch of the first UAV for transportation in Q1 of 2015. Their website reports that Matternet is creating “The ‘Apple II’ of the drone industry: the most easy to use, desirable and safest personal flying vehicle you have ever experienced.”

Amazon Prime Air—Amazon.com founder Jeff Bezos' December 2013 announcement that Amazon was planning rapid delivery of lightweight commercial products using UAVs was met with skepticism, with perceived obstacles including federal and state regulatory approval, public safety, reliability, individual privacy, operator training and certification, security (hacking), payload thievery, and logistical challenges. In July 2014, it was revealed Amazon was working on its 8th and 9th drone prototypes, some that could fly 50 miles per hour and carry 5-pound packages, and had applied to the FAA to test them. Google revealed in August 2014 it had been testing UAVs in Australia for two years. The Google X program known as “Project Wing” aims to produce drones that can deliver not only products sold via e-commerce, but larger delivery items. USPS has been testing delivery systems with HorseFly Drones. FedEx is reported to be testing integration of drone delivery with their existing logistics model. DHL Parcelcopter is already in use in Germany for the delivery of packages.

An emerging issue associated with drone delivery as becomes mainstream is with the security and protection of packages. Drones will fly to their programmed destination, land, and then drop-off a package. Unless there is a recipient waiting to receive the package, it will typically sit in the open where it is unsecured and subject to damage from weather or interference from pets or other animals. What is needed is a system that can recover and secure packages delivered by drones.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is a feature of the disclosed embodiments to provide a system for use in the secure recovery of drone delivered packages. Accordingly, a housing with an electromechanically operated door and a retractable platform that can electromechanically extend from inside the housing to outside the housing when the door is opened is disclosed.

It is another feature of the disclosed embodiments for the retractable platform serve as a landing pad for a delivery drone.

It is another feature of the disclosed embodiments for the retractable platform to move along a track or rail or telescoping arm with the retractable platform moving on wheels mounted to its underside.

It is yet another feature of the disclosed embodiments for the retractable platform to serve as a base onto which a package can be received from a delivery drone, and the retractable platform can electromechanically move back into the housing and the door to close after receiving the package.

It is yet another feature of the disclosed embodiments for actuation of the door and retractable platform to be enabled via wireless communication with the delivery drone, wherein a secure code can activate opening of the door and deployment of the retractable platform from the housing in order to receive a package from the delivery drone.

It is yet another feature of the disclosed embodiments for actuation of the door and retractable platform to be enabled via wireless communication with a remote server in association with the delivery drone, wherein location of the delivery drone near the housing causes communication of a signal from the remote server to the housing to activate opening of the door and deployment of the retractable platform from the housing in order to receive a package from the delivery drone.

It is yet another feature of the disclosed embodiments for electromechanical and communication components associated with the housing to be powered by a solar-powered and battery recharging source.

It is yet another feature of the disclosed embodiments for electromechanical components for opening the door and/or deploying the platform to be at least one of motorized, pneumatic, electromagnetic, or hydraulic.

It is yet another feature of the disclosed embodiments for electromechanical components to include a locking mechanism for the door.

It is yet another feature of the disclosed embodiments for electromechanical components to include a locking mechanism for the door that can be actuated by at least one of: a key, a pin code, a biometric provided to a biometric reader, a signal provided via wired or wireless device (e.g., smartphone, RFID card) to communication components associated with the housing.

It is yet another feature of the disclosed embodiments for the housing to include a security alarm to protect the housing and any packages contained therein from tampering or theft.

It is yet another feature of the disclosed embodiments for the housing to include a security alarm to protect the housing and any packages contained therein from tampering or theft by communicating any anomalies to a remote security monitoring service or system.

It is yet another feature of the disclosed embodiments for the housing to include, a 360-degree security camera to monitor, record, and/or transmit activity near the housing.

It is yet another feature of the disclosed embodiments for the housing to include a 360-degree security camera to monitor, record, and/or transmit activity near the housing in response to an alarm or detection of activity near the housing via sensors (e.g., motion, tampering, or thermal sensors).

It is yet another feature of the disclosed embodiments to provide a method for securing drone delivered packages. A system can be provided for use in the secure recovery of drone delivered packages, the system including a housing, electromechanical hardware, at least one electromechanically operated door operable by the electromechanical hardware securing access to the housing, a retractable platform electromechanically extendable from inside the housing by the electromechanical hardware to an area outside the housing when the at least one electromechanically operated door is opened, and communication components. The retractable platform can be configured to serve as a base onto which a package can be received from a delivery drone. At least one door can be actuated and a retractable platform deployed outside of the housing by the electromechanical hardware enabled via wireless communication of a signal between the communication components and at least one of a remote server and the delivery drone. The signal can include a secure code that activates opening of the door and deployment of the retractable platform from the housing in order to receive a package from the delivery drone, and receipt of the wireless communication of the signal by the communication components from at least one of a delivery drone occurs when the delivery drone is in close proximity to the housing. A package can be received on the platform from a delivery drone. Then, the retractable platform can be electromechanically moved back into the housing and the door closed after receiving the package from the delivery drone and after the delivery drone is no longer in close proximity to the housing.

### DRAWINGS

The accompanying figures, in which like reference numerals, refer to identical or functionally similar elements throughout the separate views and which are incorporated in and form a part of the specification, further illustrate the disclosed embodiments and, together with the detailed description of the invention, serve to explain the principles of the disclosed embodiments.

FIG. 1 illustrates a drone delivery system in accordance with features of the embodiments;

FIG. 2 illustrates a side view of a drone delivery system in accordance with features of the embodiments;

FIG. 3 illustrates a user interface and components that can be provided in association with a drone delivery system;

FIG. 4 illustrates a drone delivery system in accordance with additional features of the embodiments;

FIG. 5 illustrates a system in accordance with features of the embodiments that includes a solar panel and rechargeable batteries to supply power to the system and/or drones; and

FIG. 6 illustrates a method in accordance with features of the embodiments.

### DETAILED DESCRIPTION OF THE EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” or “at least one” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to, convey an exclusive set of factors and may, instead, allow for existence of additional factors not necessarily expressly described, again, depending at least in part on context.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an example embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a Smartphone device, a smartwatch, RFID card/tag or device, wearable computing devices, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a cellular network, a cellular node, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, and the like.

Note that the term “server” as utilized herein refers generally to a computer that provides data to other computers. Such a server can serve data to systems on, for example, a LAN (Local Area Network) or a wide area network (WAN) over the Internet. Many types of servers exist, including web servers, mail servers, and files servers. Each type can run software specific to the purpose of the server. For example, a Web server may run Apache HTTP Server or Microsoft IIS, which both provide access to websites over the Internet. A mail server may run a program such as, for example, Exim or iMail, which can provide SMPT services for sending and receiving email. A file server might utilize, for example, Samba or the operating system's built-in file sharing services to share files over a network. A server is thus a computer or device on a network that manages resources. Other examples of servers include print servers, database servers and so on. A server may be dedicated, meaning that it performs no other tasks besides their server tasks. On multiprocessing operating systems, however, a single computer can execute several programs at once. A server in this case may refer to the program that is managing resources rather than the entire computer.

Some embodiments may be used in conjunction with devices and/or networks operating in accordance with existing Long Term Evolution (LTE) specifications, e.g., “3GPP TS 36.304 3rd Generation Partnership Project; Technical Specification Group Radio Access Network; Evolved Universal Terrestrial Radio Access (E-UTRA); User Equipment (UE) procedures in idle mode”; “3GPP TS 36.331 3rd Generation Partnership Project: Technical Specification Group Radio Access Network; Evolved Universal Terrestrial Radio Access (E-UTRA); Radio Resource Control (RRC); Protocol specification”; “3GPP 24.312 3rd Generation Partnership Project; Technical Specification Group Core Network and Terminals; Access Network Discovery and Selection Function (ANDSF) Management Object (MO)”; and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee®, Ultra-Wideband (UWB), Global System for Mobile communication (GSM), second generation (2G), 2.5G, 3G, 3.5G, 4G, 5G, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1.times.RTT), Evolution-Data Optimized (EV-DO), Enhanced Data rates for GSM Evolution (EDGE), and the like. Other embodiments may be used in various other devices, systems and/or networks.

The phrase “hand held device” and/or “wireless device” and/or “mobile device” and/or “portable device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the phrase “wireless device” and/or “mobile device” may optionally include a wireless service and may also refer to wearable computing devices such as smartwatches and eyeglass computing devices (e.g., Google Glass, etc.).

A “hand held device” or HHD is a type of mobile device or wireless device, which can be held in one's hand during use, such as a smartphone, personal digital assistant (PDA), tablet computing device, laptop computer and the like. Non-HHD computing systems such as a head mounted display. It can be appreciated that such devices are not hand held devices and do not constitute an HHD since they are not used as “hand held devices” but as other types of computing devices, such as wearable computing devices. The example embodiments herein primarily describe methods and systems involving hand held devices. It can be appreciated, however, that other mobile devices such as wearable computing devices can be utilized in place of a hand held device (wearable devices are not “hand held devices” because they are not intended to be used in a user's hands, but instead worn by the user) or may be utilized with other hand held devices. For example, venue-based data as discussed herein can be streamed not only to hand held devices but also to other mobile computing devices such as wearable computing devices.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments are described herein with respect to a LTE cellular system. However, other embodiments may be implemented in any other suitable cellular network, e.g., a 3G cellular network, a 4G cellular network, a 5G cellular network, a WiMax cellular network, and the like.

The term “antenna,” as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a dipole antenna, a set of switched beam antennas, and/or the like.

The terms “cell” or “cellular” as used herein, may include a combination of network resources, for example, downlink and optionally uplink resources. The resources may be controlled and/or allocated, for example, by a cellular node (also referred to as a “base station”), or the like. The linking between a carrier frequency of the downlink resources and a carrier frequency of the uplink resources may be indicated, for example, in system information transmitted on the downlink resources.

Access points, which are often interconnected by cabling, generally play a dominant role in providing radio frequency (RF) coverage in most wireless LAN (WLAN) deployments. Wireless repeaters, though, are an alternative way to extend the range of an existing WLAN instead of adding more access points. There are very few stand-alone 802.11 wireless repeaters on the market, but some access points have a built-in repeater mode. The wireless communications electronics representing access points and wireless repeaters will be referred to herein as communications system nodes, or simply as communications nodes.

In general, a repeater simply regenerates a network signal in order to extend the range of the existing network infrastructure. A WLAN repeater does not physically connect by wire to any part of the network. Instead, it receives radio signals (802.11 frames) from an access point, end user device, or another repeater and retransmits the frames. This makes it possible for a repeater located in between an access point and distant user to act as a relay for frames traveling back and forth between the user and the access point.

As a result, wireless repeaters are an effective solution to overcome signal impairments such as RF attenuation. For example, repeaters provide connectivity to remote areas that normally would not have wireless network access. In venue deployments, temporary placement and large areas requiring coverage can result in access points that don't quite cover areas where spectators using hand held devices desire connectivity. The placement of a repeater between the covered and uncovered areas, however, can provide connectivity throughout most of the venue space. The wireless repeater fills holes in coverage, enabling seamless roaming. Although the most modern venues includes built-in wireless infrastructure, older venues often require retrofitting to incorporate wireless communications equipment, or the equipment will only be temporary and must be installed just before an event. Temporary use will be typical with multi-purpose venues. One or more embodiments can provide a system that simplifies the temporary or retrofit placement of wireless data communications equipment as pods throughout a venue.

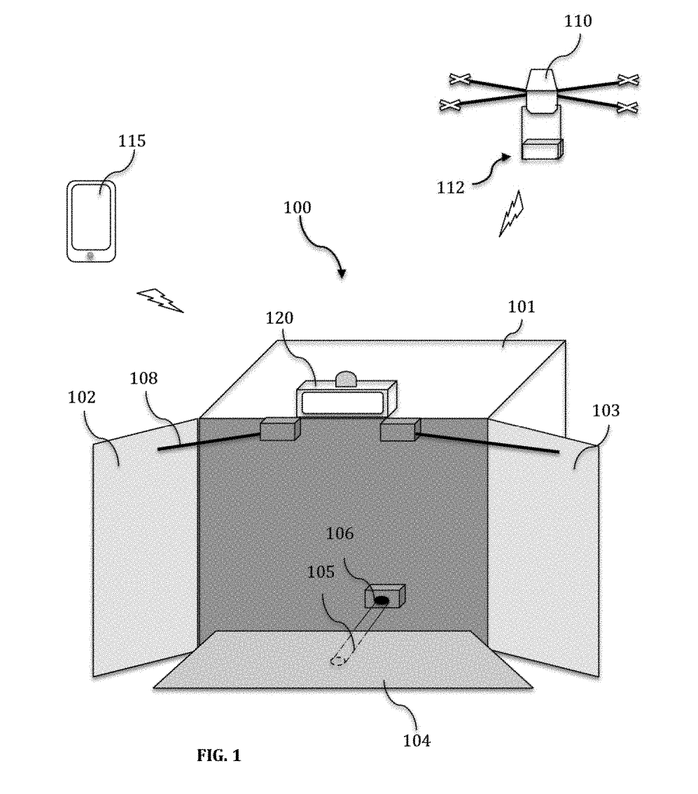

Referring to FIG. 1, a drone delivery system 100 in accordance with features of the embodiments is illustrated. A drone delivery system 100 is uniquely adapted for receiving and securing packages 112 delivered by a UAV such as a drone 110. At a minimum, it is preferred that a drone delivery system includes a housing 101, at least one electromechanically operated door 102/103, and an electromechanically retractable platform 104. The housing 101 is ideally designed to secure any contents placed therein from weather and theft. The housing 101 and doors 102/103 can be made of any material that will fulfill the need for protection from weather and theft, including steel, aluminum, plastic, wood composite materials, or any combination. Door hardware 108 can be provided to facilitate opening and closing of the doors 102/103 and can include a rod, bar, track, rail telescoping system, arms, or any other means to facilitate the opening and closing of doors from a housing. The retractable platform 104 can also be made from diverse materials, but selection should be based on an ability to support the weight of packages and be easily movable electromechanically. It is likely that the retractable platform 104 can be made of plastic or some other light composite material in order to accomplish this objective. The retractable platform 104 can be moved by hardware 105, which can be coupled to the retractable platform and facilitates both its extension outside of the housing 101 to receive a package 112, and its retraction back into the housing 101 to securely store the package 112. The hardware 105 can include a rod, bar, track, rail, telescoping system, arms, or any other means to facilitate the retractable panel's 104 movement in and out of the housing 101. Where extending member such as a rod or bar is used, a mechanical controller 106 can facilitate movement. Mechanical movement can be facilitated from the mechanical controller by any one of, or a combination of, hydraulic, pneumatic, electromechanical, or electromagnetic systems.

A system control unit 120 can be provided to manage control of the electromechanically operated doors 102/103 and retractable platform 104. The system control unit can be located within or outside of the housing 101. The system control unit 120 is shown located outside of the housing 101 for exemplary purposes only. The system control unit can also serve as the locking mechanism for the doors 102/103 (or door) when co-located near the opening of the housing 101 near the doors 102/103. The system control unit 120 can include communications components to enable wireless communication with a delivery drone 110 and/or portable device 115 (e.g., smartphone) located near the housing 101. A portable device can also be provided in the form of an RFID-enabled device (e.g., card, tag, button, keyfob).

Note that the delivery drone 110 is a type of a UAV. An unmanned aerial vehicle (UAV), commonly known as a drone, unmanned aircraft system (UAS), or by several other names, is an aircraft without a human pilot aboard. The flight of UAVs may operate with various degrees of autonomy: either under remote control by a human operator, or fully or intermittently autonomously, by onboard computers. The drone 110 can be implemented as a flying body that flies through remote control without a person boarding or flies autonomously along a designated path. The drone 110 may include any type of flying body that can fly through remote control without a person boarding or fly autonomously along a designated path, and is not limited to a specific name and type.

One non-limiting example of a drone or system of UAVs that can be implemented in accordance with one example embodiment or adapted for use in accordance with such an example embodiment, is disclosed in U.S. Pat. No. 9,583,007, entitled “Dynamic selection of unmanned aerial vehicles,” which issued on Feb. 28, 2017 and incorporated herein by reference in its entirety. Another non-limiting example of a drone/UAV and a system thereof, which can be implemented in accordance with an alternative example embodiment or adapted for use with such an alternative example embodiment, is disclosed in U.S. Pat. No. 9,580,173, entitled “Translational Correction of Payload-Release Device Based on a Tracked Position,” which issued on Feb. 28, 2017 and is incorporated herein by reference in its entirety.

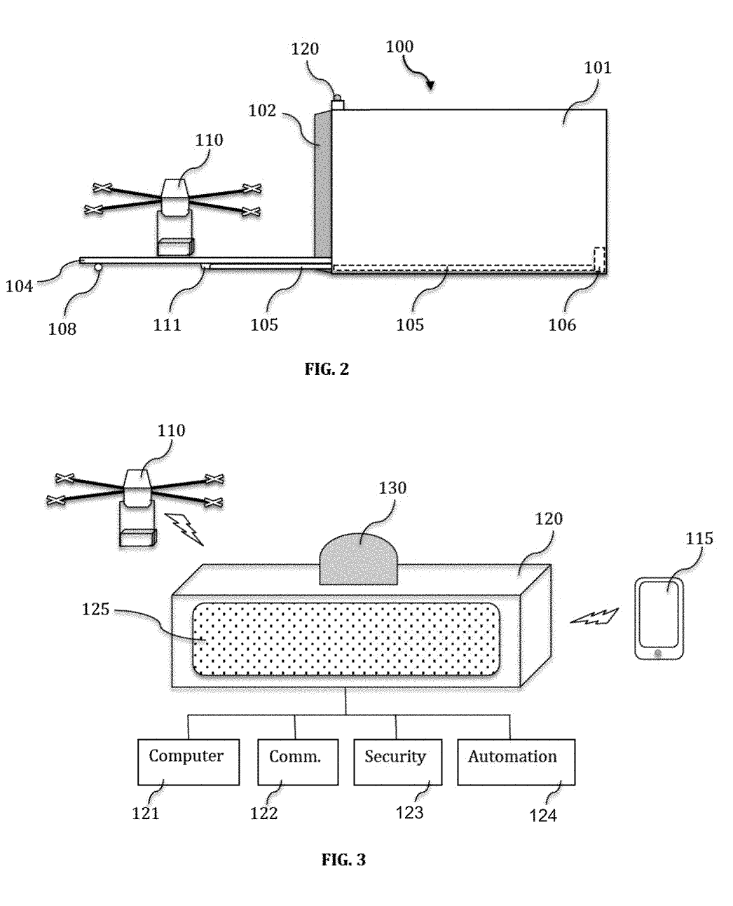

Referring to FIG. 2, illustrated is a side view of the system 100 described in FIG. 1. In this figure, a drone 110 is shown placing a package onto the retractable platform 104. At least one wheel 108 can be mounted to the bottom of the retractable platform 104 in order to facilitate its movement outside of the housing 101, and back into the housing 101. Wheels can be provided that will traverse smooth surfaces (e.g., concrete, pavement, wood decking, roofing material) or rough surface (e.g., gravel or dirt earth). Ideally, the system 101 would be mounted on a concrete pad or wood decking near a recipients home or facility.

Referring to FIG. 3, a diagram of the system control unit 120 is further illustrated. A system control unit 120 can include a computer 121, communications components 122, security components 123, and automation control components 124, either within or in, association with the system control unit 120, in accordance with additional embodiments, is illustrated. The computer 121 can enable overall control of the electromechanical, security, and communications features of the system 101. The communications components 122 can facilitate wireless communications with a portable handheld device 115 (e.g., smartphone RFD device), which can typically be carried by a user to access packaged within the housing 101 by causing the doors 102/103 and/or retractable platform to open and facilitate retrieval of packages stored within the housing 101. The automation control components 124 can facilitate initiation and movement of electromechanical hardware 105/106, etc., associated with the doors 102/103 and retractable platform 104. The communications components can also facilitate wireless communications with a delivery drone 110 located near the housing 101, and enable the opening of doors 102/103 and deployment of the retractable platform 104 from the housing 101 in order to facilitate placement of a package thereon by a delivery drone 110. It should also be appreciated that the communications components 122 can facilitate communications over wireless and wired data communications networks to access, or to be accessed by, remote system (e.g., remote servers and operators).

A user interface 125 can be provided to facilitate a user's (owner/manager of the box) ability to open doors 102/103 and/or deploy the retractable platform 104 in order to access packages being securely held within the housing 101. A locking mechanism in association with the system control unit 120 can also unlock doors 102/103 (or a door) to the housing and enable a person with access inside the housing 101. The user interface 125 can include a variety of user controls that can be physically accessed by a user to obtain access to within the housing 101, including any combination of: touch sensitive display screens, biometric readers, key locks, buttons, switches, lights, etc.). A pin number, biometric, wirelessly provided signal from a smartphone 115 or RFID-enabled device, or regular key can be used to obtain access via the system control unit 120.

Security components 123 can provide sensors and alarms if intrusion is detected. Sensors can include those that provide an indication of an event that is related to motion, thermal, and environmental events. Any condition can trigger an alarm at the housing 101. A signal can also be provided to remote alarm monitoring services or a user's remote portable device 115. A 360-degree security camera 130 can also be provided as a security feature to provide a user or remote monitors the ability to view activity around the housing 101. The 360-camera can also facilitate operator drone movement near the housing 101.

Note that in some example embodiments, the computer 121 (which includes at least a memory, a controller, peripherals, and data-processing components such as one or more microprocessors, etc.) may store and process instructions based on machine-learning instructions. Such machine-learning instructions may direct the operations of the drone 110 and/or the drone delivery system 200 along with the operations of, for example, components such as the camera 130, the housing 101, and so on. Note that the term “machine learning” as utilized herein is a type of artificial intelligence (AI) that provides computers with the ability to learn without being explicitly programmed. Machine learning focuses on the development of computer programs that can change when exposed to new data. The process of machine learning is similar to that of data mining.

One non-limiting example of a machine learning application that can be utilized to instruct the computer 121 and the operations of the drone delivery system 200 is disclosed in accordance with an example embodiment is disclosed in U.S. Pat. No. 9,489,569, which issued on Nov. 8, 2016, and is incorporated herein by reference in its entirety. Another non-limiting example of a machine learning application that can be implemented in accordance with another example embodiment is disclosed in U.S. Pat. No. 9,454,732, which issued on Sep. 27, 2016 and is incorporated herein by reference in its entirety.

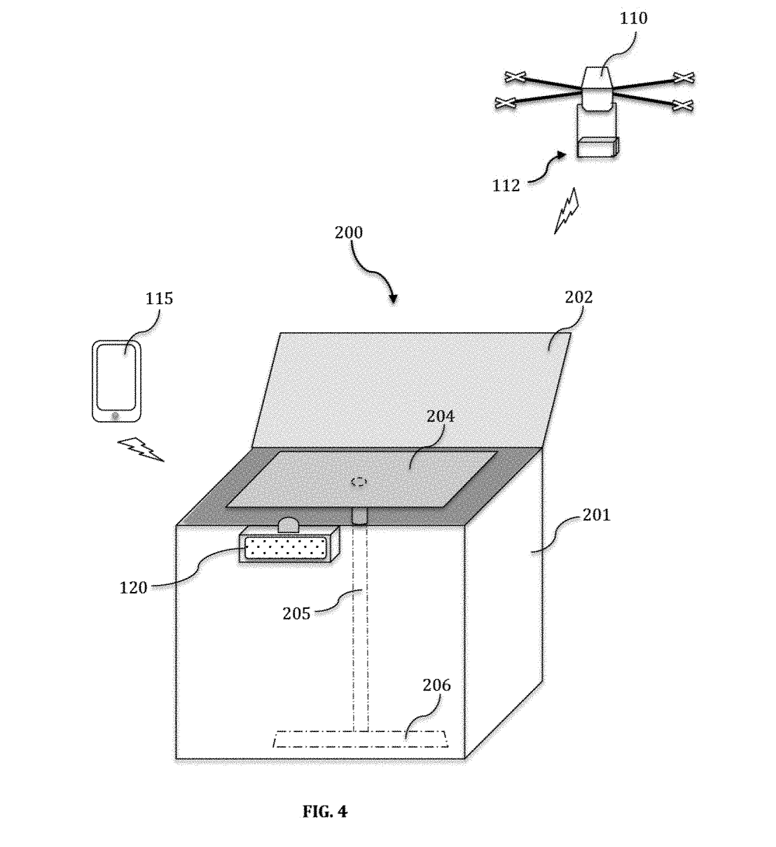

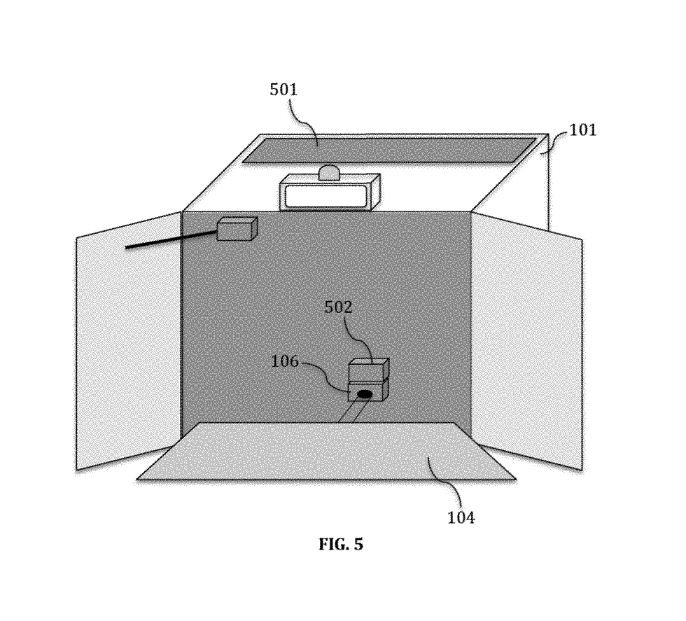

Referring to FIG. 4, illustrated is a drone delivery system 200 in accordance with additional features of the embodiments. A housing 201 can be provided with at least one door 202 that service as the top of the housing and opens upward to reveal the inside of the housing 201. A retractable platform 204 can be moved to a position outside of the housing 201 via hardware 205/206, similar to the hardware discussed with respect to FIG. 1. In the present embodiment, the platform is provided in the form of a lift (up/down) rather than a sled (horizontal movement in/out). The system 200 can include a system control unit 120 that can communicate with delivery drones 110 and portable devices 115 carried by users, or with remote servers (not shown), as discussed above.

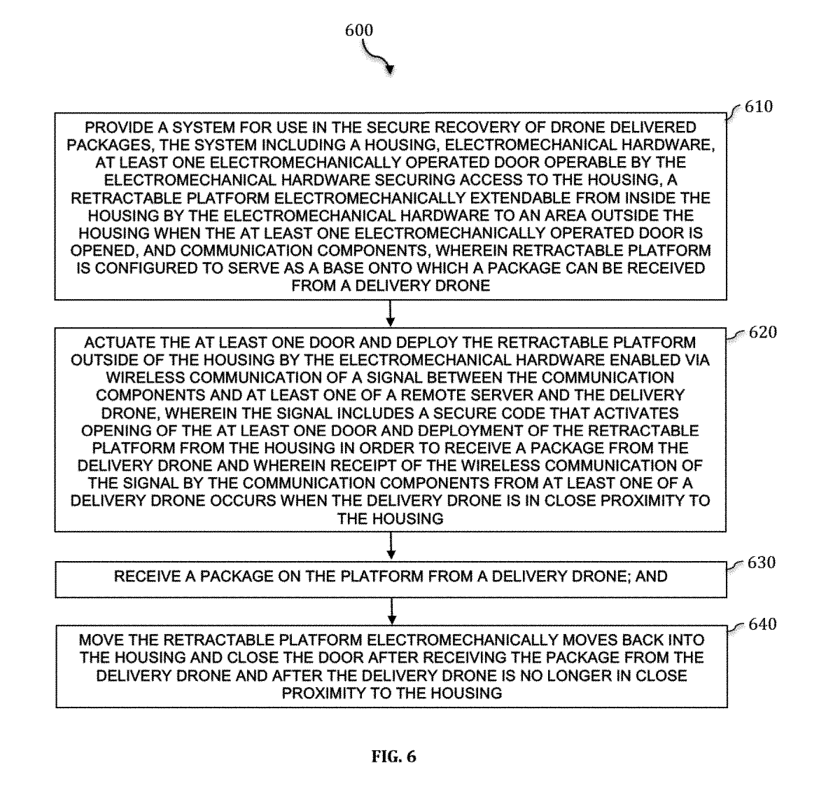

Referring to FIG. 5, illustrated is a system in accordance with features of the embodiments that includes a solar panel 501 and rechargeable batteries 502. In field deployments where power and communications connections are not feasible or possible, it would be desirable to provide solar power capabilities. A solar panel can be mounted to the top surface of the housing 101, as shown. In the alternative embodiment of FIG. 5, the solar panel 501 can be mounted to the exterior surface of door 202. With off the grid power being supplied, and communications provided wirelessly, the system 100 can be more flexible and be deployed in various use scenarios.

Referring to FIG. 6, a method of securing drone delivered packages in accordance with the features embodiments is illustrated. Referring to block 610, a system is provided for use in the secure recovery of drone delivered packages, the system including a housing, electromechanical hardware, at least one electromechanically operated door operable by the electromechanical hardware securing access to the housing, a retractable platform electromechanically extendable from inside the housing by the electromechanical hardware to an area outside the housing when the at least one electromechanically operated door is opened, and communication components, wherein retractable platform is configured to serve as a base onto which a package can be received from a delivery drone. Referring to block 620, at least one door is actuated and the retractable platform is deployed outside of the housing by the electromechanical hardware enabled via wireless communication of a signal between the communication components and at least one of a remote server and the delivery drone. The signal can include a secure code that activates opening of the door and deployment of the retractable platform from the housing in order to receive a package from the delivery drone, and receipt of the wireless communication of the signal by the communication components from at least one of a delivery drone occurs when the delivery drone is in close proximity to the housing. As shown in block 630, a package is received on the platform from a delivery drone. Then, as shown in block 640, the retractable platform is electromechanically moved back into the housing and the door closes after receiving the package from the delivery drone and after the delivery drone is no longer in close proximity to the housing.

It can be appreciated that the claims, description, and drawings of this application may describe one or more of the instant technologies in operational/functional language, for example as a set of operations to be performed by a computer (e.g., computer 121) Such operational/functional description in most instances can be specifically-configured hardware (e.g., because a general purpose computer in effect becomes a special-purpose computer once it is programmed to perform particular functions pursuant to instructions from program software). Note that the computer (e.g., computer 121) or data-processing system discussed herein may be implemented as special-purpose computer in some example embodiments. In some example embodiments, such data-processing system or computer can be programmed to perform the aforementioned particular instructions thereby becoming in effect a special-purpose computer.

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, Java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an example embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built, up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modem microprocessor will often contain more than one hundred million logic gates in its many logic circuits (and often more than a billion transistors).

The logic circuits forming the microprocessor are arranged to provide a micro architecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state may be used to construct a machine based on the above technical description. Charles Babbage, for example, constructed the first computer out of wood and powered by cranking a handle.

Thus, far from being understood as an abstract idea, it can be recognized that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those skilled in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person skilled in the art in understanding the described subject matter by providing a description that is more or less independent of any specific vendor's piece(s) of hardware.

The use of functional/operational technical descriptions assists the person skilled in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person skilled in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one skilled in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc. in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at, least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A system for use in the secure recovery of drone delivered packages, comprising:
a housing;
at least one electromechanically operated door securing access to the housing; and
a retractable platform that can electromechanically extend from inside the housing to an area outside the housing when the at least one electromechanically operated door is opened.

2. The system of claim 1, wherein the retractable platform is configured to serve as a landing pad for at least one of a delivery drone and packages carried by the delivery drone.

3. The system of claim 1, further comprising wheels mounted to an underside of the platform to enable the platform movement along flooring supporting the housing.

4. The system of claim 1, further comprising at least one of a track, rail, or telescoping arm, wherein the retractable platform is movable in and out of the housing along the at least one of a track, rail, or telescoping arm.

5. The system of claim 4, further comprising wheels mounted to an underside of the platform to enable the platform movement along flooring supporting the housing as the retractable platform moves in and out of the housing along the at least one of a track, rail, or telescoping arm.

6. The system of claim 4, wherein the retractable platform is configured to serve as a base onto which a package can be received from a delivery drone, and the retractable platform can electromechanically move back into the housing and the door to close after receiving the package.

7. The system of claim 1, further comprising electromechanical hardware and communication components with the housing.

8. The system of claim 7, wherein actuation of the at least one door and deployment of the retractable platform outside of the housing by the electromechanical hardware is enabled via wireless communication of the communication components with the delivery drone, wherein a secure code activates opening of the door and deployment of the retractable platform from the housing in order to receive a package from the delivery drone.

9. The system of claim 1, wherein electromechanical actuation of the at least one door and outward deployment of the retractable platform by the electromechanical hardware in order to receive a package from the delivery drone is enabled via receipt of a wireless communication of a signal by the communication components from at least one of a delivery drone in close proximity to the housing or a remote server in association with the delivery drone when the delivery drone indicates to the server that it is in close proximity to the housing.

10. The system of claim 1, wherein the electromechanical hardware and the communication components are powered by a solar-powered and battery rechargeable source.

11. The system of claim 1, wherein the electromechanical hardware for opening the door and/or deploying the platform further comprises at least one of motorized, pneumatic, or hydraulic components.

12. The system of claim 1, wherein the electromechanical hardware further includes a locking mechanism for the door.

13. The system of claim 1, wherein the locking mechanism further comprises at least one of a keyed lock, biometrically controlled lock, or a wirelessly actuated lock, wherein the door that can be actuated by a user using at least one of: a key, a biometric provided to a biometric reader, or a signal provided wirelessly to communication components associated with the locking mechanism and the housing.

14. The system of claim 1, further comprising a security alarm associated with the using to protect the housing and any packages contained therein from tampering or theft.

15. The system of claim 1, wherein the housing further comprises a security alarm adapted to protect the housing and any packages contained therein from tampering or theft by wirelessly communicating a signal indicating any anomalies to a remote security monitoring service or system.

16. The system of claim 1, further comprising a 360-degree security camera to monitor, record, and/or transmit activity occurring near the housing.

17. The system of claim 1, further comprising a 360-degree security camera to monitor, record, and/or transmit activity near the housing in response to an alarm or detection of activity near the housing via sensors.

18. The system of claim 6 wherein said delivery drone and said retractable platform are controlled by to a machine learning application.

19. The system of claim 16 wherein said 360-degree security camera is controlled by a machine learning application.

20. A method of securing drone delivered packages, comprising:
providing a system for use in the secure recovery of drone delivered packages, the system including a housing, electromechanical hardware, at least one electromechanically operated door operable by the electromechanical hardware securing access to the housing, a retractable platform electromechanically extendable from inside the housing by the electromechanical hardware to an area outside the housing when the at least one electromechanically operated door is opened, and communication components, wherein retractable platform is configured to serve as a base onto which a package can be received from a delivery drone;
actuate at least one door and deploy the retractable platform outside of the housing by the electromechanical hardware enabled via wireless communication of a signal between the communication components and at least one of a remote server and the delivery drone, wherein the signal includes a secure code that activates opening of the door and deployment of the retractable platform from the housing in order to receive a package from the delivery drone and wherein receipt of the wireless communication of the signal by the communication components from at least one of a delivery drone occurs when the delivery drone is in close proximity to the housing;
receive a package on the platform from a delivery drone; and
move the retractable platform electromechanically back into the housing and close the door after receiving the package from the delivery drone and after the delivery drone is no longer in close proximity to the housing.
